(19) United States
(12) Patent Application Publication
(10) Pub. No.: US 2020/0389883 A1
(43) Pub. Date: Dec. 10, 2020

(54) CONFIGURING SPATIAL QCL REFERENCE IN A TCI STATE

(71) Applicant: TELEFONAKTIEBOLAGET LM ERICSSON (PUBL), Stockholm (SE)

(72) Inventors: Sebastian FAXÉR, JÄRFÄLLA (SE); Stephen GRANT, PLEASANTON, CA (US); Helka-Liina MÄÄTTANEN, HELSINKI (FI); Siva MURUGANATHAN, STITTSVILLE (CA)

(21) Appl. No.: 16/764,168

(22) PCT Filed: Nov. 16, 2018
(86) PCT No.: PCT/IB2018/059058

§ 371 Date: May 14, 2020

Related U.S. Application Data
(60) Provisional application No. 62/587,441, filed on Nov. 16, 2017.

(51) Int. Cl. H04W 72/04; H04B 7/06; H04L 5/00

(52) U.S. Cl. CPC H04W 72/046; H04B 7/0626; H04L 5/0025; H04W 72/042; H04L 5/0048; H04L 5/0057; H04L 5/0035

(57) ABSTRACT

Systems and methods for configuring a QCL reference associated with a TCI state are provided. A plurality of TCI states are RRC configured including at least one candidate reference signal for QCL reference. A control message can be used to update the reference signal be used as an updated QCL reference for an identified active TCI state.

### CROSS REFERENCE TO RELATED APPLICATIONS

This application claims the benefit of U.S. Provisional Application No. 62/587,441 filed on Nov. 16, 2017, the entire contents of which are hereby incorporated by reference.

### TECHNICAL FIELD

The present disclosure generally relates to wireless communications and wireless communication networks.

### INTRODUCTION

The architecture for New Radio (NR) (also known as 5G or Next Generation) is being discussed in standardization bodies such as 3GPP. FIG. 1 illustrates an example of a wireless network 100 that can be used for wireless communications. Wireless network 100 includes UEs 102A-102B and a plurality of network nodes, such as radio access nodes 104A-104B (e.g. eNBs, gNBs, etc.) connected to one or more network nodes 106 via an interconnecting network 115. The network 100 can use any suitable deployment scenarios. UEs 102 within coverage area 108 can each be capable of communicating directly with radio access node 104A over a wireless interface. In some embodiments, UEs 102 can also be capable of communicating with each other via D2D communication.

As an example, UE 102A can communicate with radio access node 104A over a wireless interface. That is, UE 102A can transmit wireless signals to and/or receive wireless signals from radio access node 104A. The wireless signals can contain voice traffic, data traffic, control signals, and/or any other suitable information. In some embodiments, an area of wireless signal coverage associated with a radio access node 104A can be referred to as a cell 108.

The interconnecting network 125 can refer to any interconnecting system capable of transmitting audio, video, signals, data, messages, etc., or any combination of the preceding. The interconnecting network 125 can include all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, or any other suitable communication link, including combinations thereof.

In some embodiments, the network node 130 can be a core network node 130, managing the establishment of communication sessions and other various other functionalities for UEs 110. Examples of core network node 130 can include mobile switching center (MSC), MME, serving gateway (SGW), packet data network gateway (PGW), operation and maintenance (O&M), operations support system (OSS), SON, positioning node (e.g., Enhanced Serving Mobile Location Center, E-SMLC), MDT node, etc. UEs 110 can exchange certain signals with the core network node using the non-access stratum layer. In non-access stratum signaling, signals between UEs 110 and the core network node 130 can be transparently passed through the radio access network. In some embodiments, radio access nodes 120 can interface with one or more network nodes over an internode interface.

System information, including the control information required for a UE 102 to access the cell 108, is periodically broadcast by the radio access node(s) 104. Some uncertainty may exist between the UE 102 and the network related to the delivery of this system information.

In Long Term Evolution (LTE) networks, until Release 13, all reference signals (RSs) that a UE uses for channel state information (CSI calculation) (e.g. CRS and CSI-RS), were non-precoded such that the UE can measure the raw channel and calculate CSI feedback including preferred precoding matrix based on that. As the number of Tx (transmit) antenna ports increases, the amount of feedback becomes larger. For example, in LTE Release 10, when support for 8 Tx closed loop precoding was introduced, a double codebook approach was introduced where a UE first selects a wideband coarse precoder and then selects a second codeword per sub band. Another possible approach is that the network beamforms the CSI-RS and the UE calculates CSI feedback using the beamformed CSI-RS. This approach was adopted in LTE Release 13 as one option for the FD-MIMO.

Release 13 FD-MIMO specification in LTE supports an enhanced CSI-RS reporting called Class B for beamformed CSI-RS. Therein, an LTE RRC_CONNECTED UE can be configured with K beams (where 1<K≤8) where each beam can consist of 1, 2, 4 or 8 CSI-RS ports. For CSI feedback purposes (PMI, RI and CQI), there is a CSI-RS Resource Indicator per CSI-RS. As part of the CSI, the UE reports CSI-RS index (CRI) to indicate the preferred beam where the CRI is wideband. Other CSI components such as RI/CQI/PMI are based on legacy codebook (i.e. Release 12) and CRI reporting periodicity is an integer multiple of the RI reporting periodicity. An example of beamformed CSI-RS is illustrated in FIG. 2. In FIG. 2, the UE 102A reports CRI=2 which corresponds to RI/CQI/PMI being computed using “Beamformed CSI-RS 2”.

For Release 14, eFD-MIMO, non-periodic beamformed CSI-RS with two different sub-flavors was introduced. The two sub-flavors are aperiodic CSI-RS and semi-persistent CSI-RS. In both these flavors, the CSI-RS resources are configured for the UE as in Release 13 with K CSI-RS resources, and Medium Access Control (MAC) control element (CE) activation of N out of K CSI-RS resources (N≤K) is specified. Alternatively stated, after the K CSI-RS resources are configured to be aperiodic CSI-RS or semi-persistent CSI-RS, the UE waits for MAC CE activation of N out of K CSI-RS resources. In the case of aperiodic CSI-RS, in addition to MAC CE activation, a DCI trigger is sent to the UE so that one of the activated CSI-RS resources is selected by the UE for CSI computation and subsequent reporting. In the case of semi-persistent CSI-RS, once the CSI-RS resources are activated by MAC CE, the UE can use the activated CSI-RS resources for CSI computation and reporting.

The MAC CE activation/deactivation command is specified in 3GPP TS 36.321 Section 5.19 which will be detailed below.

The network may activate and deactivate the configured CSI-RS resources of a serving cell by sending the Activation/Deactivation of CSI-RS resources MAC control element described in subclause 6.1.3.14. The configured CSI-RS resources are initially deactivated upon configuration and after a handover.

Section 6.1.3.14 of TS 36.321 describes:

The Activation/Deactivation of CSI-RS resources MAC control element is identified by a MAC PDU subheader with LCID as specified in table 6.2.1-1. It has variable size as the number of configured CSI process (N) and is defined in Figure 6.1.3.14-1. Activation/Deactivation CSI-RS command is defined in Figure 6.1.3.14-2 and activates or deactivates CSI-RS resources for a CSI process. Activation/Deactivation of CSI-RS resources MAC control element applies to the serving cell on which the UE receives the Activation/Deactivation of CSI-RS resources MAC control element.

The Activation/Deactivation of CSI-RS resources MAC control elements is defined as follows:
Rᵢ: this field indicates the activation/deactivation status of the CSI-RS resources associated with CSI-RS-ConfigNZPId i for the CSI-RS process. The Rᵢ field is set to “1” to indicate that CSI-RS resource associated with CSI-RS-ConfigNZPId i for the CSI-RS process shall be activated. The Rᵢ field is set to “0” to indicate that the CSI-RS-ConfigNZPId i shall be deactivated;

The MAC activation was introduced in LTE to be able to configure the UE with more CSI-RS resources than the maximum number of CSI-RS resources the UE is able to support for CSI feedback. The MAC CE would then selectively activate up to the maximum number of CSI-RS resources supported by the UE for CSI feedback. The benefit of MAC CE activation for CSI-RS is that the network can, without the need to reconfigure by RRC, activate another set of N CSI-RS resources among the K resources configured for the UE.

In NR, all reference signals can be beamformed. In NR, the synchronization sequences (NR-PSS/NR-SSS) and PBCH, which includes DMRS, constitute a “SS Block”. An RRC_CONNECTED UE trying to access a target cell should assume that the SS Block may be transmitted in the form of repetitive bursts of SS Block transmissions (denoted as “SS Burst”), wherein such a burst consists of a number of SS Block transmissions following close after each other in time. Furthermore, a set of SS Bursts may be grouped together (denoted as “SS Burst Set”), where the SS Bursts in the SS Burst Sets are assumed to have some relation to each other. Both SS Bursts and SS Burst Sets have their respective given periodicity.

As shown in FIG. 3, in single beam scenarios, the network could configure time-repetition within one SS Burst in a wide beam. Also show in FIG. 3, in multi-beam scenarios, at least some of these signals and physical channels (e.g. SS Block) would be transmitted in multiple beams, which could be done in different manners depending on network implementation.

The first (top) example of FIG. 3 illustrates time-repetition within one SS Burst in a wide beam by access node 104A. The second (middle) example of FIG. 3 illustrates beam-sweeping of a small number of beams using only one SS Burst in the SS Burst Set by access node 104B. The third (bottom) example of FIG. 3 illustrates beam-sweeping of a larger number of beams using more than one SS Burst in the SS Burst Set to form a complete sweep by access node 104C.

Which of these three alternatives to implement is a network vendor/operator choice. That choice depends on the tradeoff between i) the overhead caused by transmitting periodic and always on narrow beam sweepings vs. ii) the delays and signaling needed to configure the UE to find a narrow beam for PDSCH/PDCCH. The implementation shown in the first (top) example of FIG. 3 prioritizes i), while the implementation shown in the third (bottom) example of FIG. 3 prioritizes ii). The second (middle) example is an intermediate case, where a sweeping of wide beams is used. In that case, the number of beams to cover the cell is reduced, but in some cases an additional refinement is needed for narrow gain beamforming of PDSCH.

In NR, the following types of CSI reporting are supported:

Periodic CSI Reporting: CSI is reported periodically by the UE. Parameters such as periodicity and slot offset are configured semi-statically, by higher layer signaling from the gNB to the UE.

Aperiodic CSI Reporting (AP CSI Reporting): This type of CSI reporting involves a single-shot (i.e., one time) CSI report by the UE which is dynamically triggered by the gNB, e.g. by the DCI in PDCCH. Some of the parameters related to the configuration of the aperiodic CSI report is semi-statically configured from the gNB to the UE but the triggering is dynamic.

Semi-Persistent CSI Reporting: Similar to periodic CSI reporting, semi-persistent CSI reporting has a periodicity and slot offset which may be semi-statically configured by the gNB to the UE. However, a dynamic trigger from gNB to UE may be needed to allow the UE to begin semi-persistent CSI reporting. In some cases, a dynamic trigger from gNB to UE may be needed to command the UE to stop the semi-persistent transmission of CSI reports.

Generally, a CSI report setting contains the parameters associated with CSI reporting including the type of CSI reporting.

In NR, the following three types of CSI-RS transmissions are supported:

Periodic CSI-RS (P CSI-RS): CSI-RS is transmitted periodically in certain slots. This CSI-RS transmission is semi-statically configured using parameters such as CSI-RS resource, periodicity and slot offset. For CSI acquisition, a single semi-persistent CSI-RS resource is contained within a CSI-RS resource set.

Aperiodic CSI-RS (AP CSI-RS): This is a one-shot CSI-RS transmission that can happen in any slot. Here, one-shot means that CSI-RS transmission only happens once per trigger. The CSI-RS resources (i.e., the resource element locations which consist of subcarrier locations and OFDM symbol locations) for aperiodic CSI-RS are semi-statically configured. The transmission of aperiodic CSI-RS is triggered by dynamic signaling through PDCCH. The triggering may also include selecting a CSI-RS resource from multiple CSI-RS resources. Multiple aperiodic CSI-RS resources can be grouped into a CSI-RS resource set.

Semi-Persistent CSI-RS (SP CSI-RS): Similar to periodic CSI-RS, resources for semi-persistent CSI-RS transmissions are semi-statically configured with parameters such as periodicity and slot offset. However, unlike periodic CSI-RS, dynamic signaling is needed to activate and possibly deactivate the CSI-RS transmission. For CSI acquisition, a single semi-persistent CSI-RS resource is contained within a CSI-RS resource set.

In the case of aperiodic CSI-RS and/or aperiodic CSI reporting, the gNB RRC configures the UE with S_{c} CSI triggering states. Each triggering state contains the aperiodic CSI report setting to be triggered along with the associated aperiodic CSI-RS resource sets.

When the DCI contains a CSI request field with N bits, aperiodic CSI-RS and/or aperiodic CSI reporting can be triggered according to the following conditions:

Condition 1: When the number of triggering states S_{c}≤(2^{N}−1), MAC CE activation/deactivation is not used and DCI will trigger one out of the S_{c}.

Condition 2: When the number of triggering states S_{c}>(2^{N}−1), MAC CE activation is used to activate (2^{N}−1) triggering states. Then, DCI will trigger the aperiodic CSI-RS and/or aperiodic CSI reporting associated with one out of the (2^{N}−1) triggering states. MAC CE can deactivate the currently active triggering states and activate a new set of (2^{N}−1) triggering states.

In NR, the size of the CSI request field is configurable and can take on values of N={0, 1, 2, . . . , Nₘₐₓ}. The value of Nₘₐₓ is still under discussion in 3GPP and is to be down-selected from one of the candidate values of {3, 4, 5, 6, 7, 8}.

### SUMMARY

It is an object of the present disclosure to obviate or mitigate at least one disadvantage of the prior art.

In aspects of the present disclosure, there are provided systems and methods for configuring and/or updating a QCL reference associated with a TCI state.

In a first aspect of the present disclosure, there is provide a method performed by a wireless device. The wireless device can comprise a radio interface and processing circuitry and be configured to obtain a radio resource control (RRC) message including a plurality of Transmission Configuration Indicator (TCI) states, wherein each of the plurality of TCI states includes a TCI state identifier and at least one candidate reference signal for quasi co-location (QCL) reference. The wireless device receives a control message including an identifier of an active TCI state to be updated and an indication of a reference signal to be used as an updated QCL reference for the identified active TCI state. The wireless device updates the QCL reference for the identified active TCI state to the indicated reference signal.

In some embodiments, the control message is a Medium Access Control (MAC) control element (CE).

In some embodiments, the indication of a reference signal indicates at least one of a reference signal type and a reference signal to be used as the updated QCL reference. In some embodiments, the indication of a reference signal indicates a reference signal index to be used as the updated QCL reference. In some embodiments, the indicated reference signal is one of the candidate reference signals for the active TCI state.

In some embodiments, the control message further includes updated QCL references for a plurality of active TCI states.

In some embodiments, the wireless device performs at least one radio measurement. In some embodiments, the wireless device can transmit a radio measurement report to a network node.

In some embodiments, the wireless device uses at least one of a transmission and reception beam associated with the indicated reference signal to be used as the updated QCL reference.

In some embodiments, the RRC message and/or the control message is received from a network node.

In another aspect of the present disclosure, there is provide a method performed by a network node. The network node can comprise a radio interface and processing circuitry and be configured to transmit a radio resource control (RRC) message including a plurality of Transmission Configuration Indicator (TCI) states, wherein each of the plurality of TCI states includes a TCI state identifier and at least one candidate reference signal for quasi co-location (QCL) reference. The network node generates a control message including an identifier of an active TCI state to be updated and an indication of a reference signal to be used as an updated QCL reference for the identified active TCI state. The network node transmits the control message.

In some embodiments, the control message is a Medium Access Control (MAC) control element (CE).

In some embodiments, the indication of a reference signal indicates at least one of a reference signal type and a reference signal to be used as the updated QCL reference. In some embodiments, the indication of a reference signal indicates a reference signal index to be used as the updated QCL reference. In some embodiments, the indicated reference signal is one of the candidate reference signals for the active TCI state.

In some embodiments, the control message further includes updated QCL references for a plurality of active TCI states.

In some embodiments, the network node determines that a QCL reference associated with the active TCI state should be updated. In some embodiments, the control message is generated in response to determining that the QCL reference associated with the active TCI state should be updated.

In some embodiments, the network node receives at least one radio measurement report from a wireless device. In some embodiments, the network node determines that the QCL reference associated with the active TCI state should be updated in accordance with the radio measurement report.

In some embodiments, the RRC message and/or the control message is transmitted to a wireless device.

The various aspects and embodiments described herein can be combined alternatively, optionally and/or in addition to one another.

Other aspects and features of the present disclosure will become apparent to those ordinarily skilled in the art upon review of the following description of specific embodiments in conjunction with the accompanying figures.

### BRIEF DESCRIPTION OF THE DRAWINGS

Embodiments of the present disclosure will now be described, by way of example only, with reference to the attached Figures, wherein:

FIG. 1 illustrates an example wireless network;

FIG. 2 illustrates an example of beamformed CSI-RS;

FIG. 3 illustrates examples of configuration of an SS Burst Set;

FIG. 4 illustrates an example TCI framework;

FIG. 5 is an example first octet of a MAC CE message;

FIG. 6 is an example signaling diagram;

FIG. 7 is a flow chart illustrating an example method performed in a network node;

FIG. 8 is a flow chart illustrating an example method performed in a wireless device;

FIG. 9 is a block diagram of an example wireless device;

FIG. 10 is a block diagram of an example wireless device with modules;

FIG. 11 is a block diagram of an example network node; and

FIG. 12 is a block diagram of an example network node with modules.

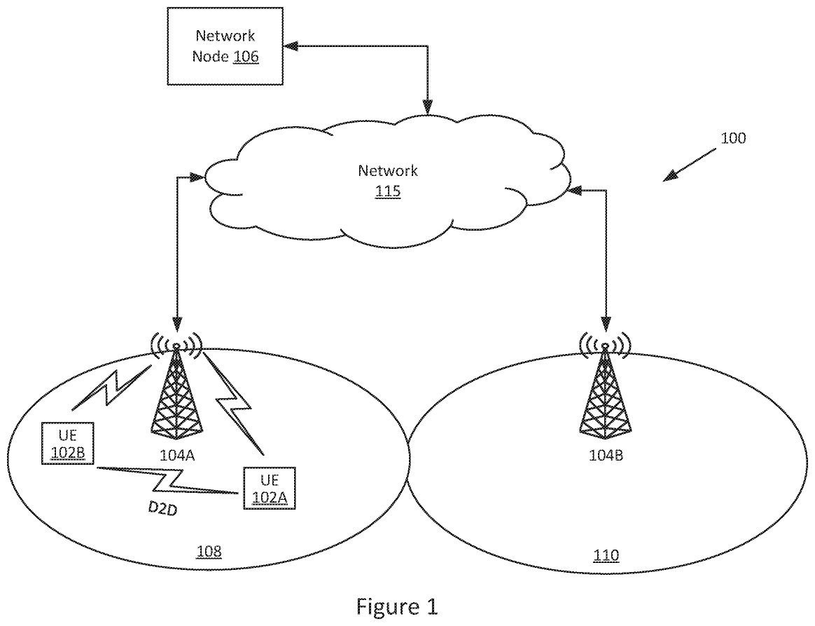

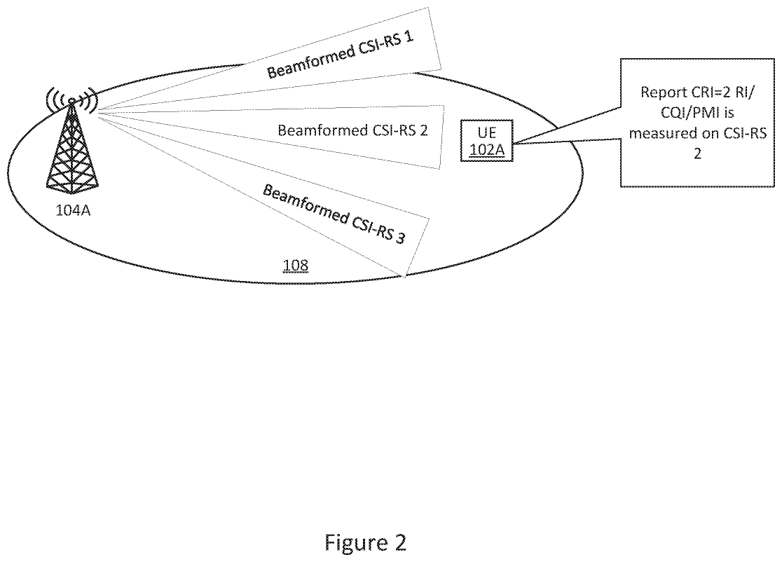

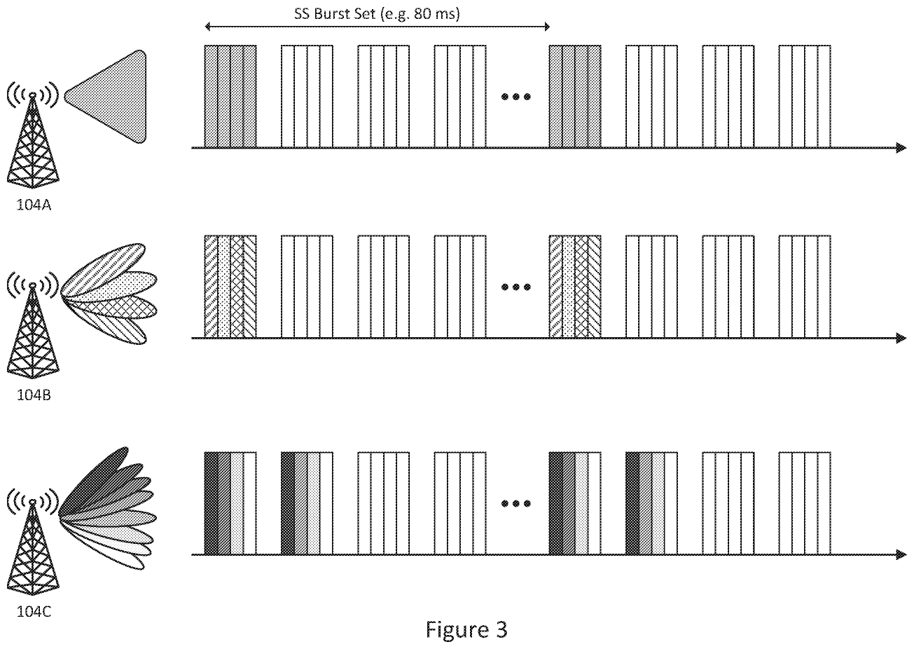

### DETAILED DESCRIPTION

The embodiments set forth below represent information to enable those skilled in the art to practice the embodiments. Upon reading the following description in light of the accompanying drawing figures, those skilled in the art will understand the concepts of the description and will recognize applications of these concepts not particularly addressed herein. It should be understood that these concepts and applications fall within the scope of the description.

In the following description, numerous specific details are set forth. However, it is understood that embodiments may be practiced without these specific details. In other instances, well-known circuits, structures, and techniques have not been shown in detail in order not to obscure the understanding of the description. Those of ordinary skill in the art, with the included description, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

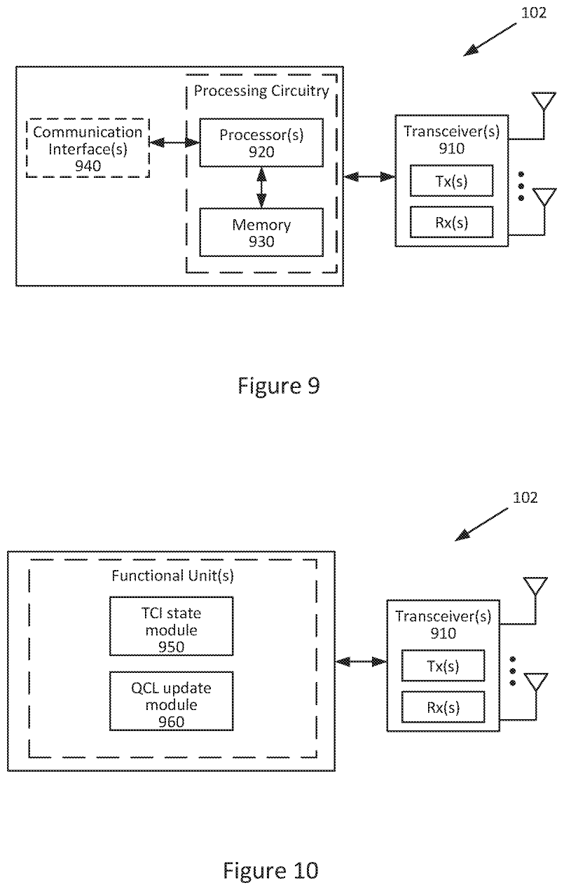

In some embodiments, the non-limiting term “user equipment” (UE) is used and it can refer to any type of wireless device which can communicate with a network node and/or with another UE in a cellular or mobile or wireless communication system. Examples of UE are target device, device to device (D2D) UE, machine type UE or UE capable of machine to machine (M2M) communication, personal digital assistant, tablet, mobile terminal, smart phone, laptop embedded equipped (LEE), laptop mounted equipment (LME), USB dongles, ProSe UE, V2V UE, V2X UE, MTC UE, eMTC UE, FeMTC UE, UE Cat 0, UE Cat M1, narrow band IoT (NB-IoT) UE, UE Cat NB1, etc. Example embodiments of a UE are described in more detail below with respect to FIG. 9.

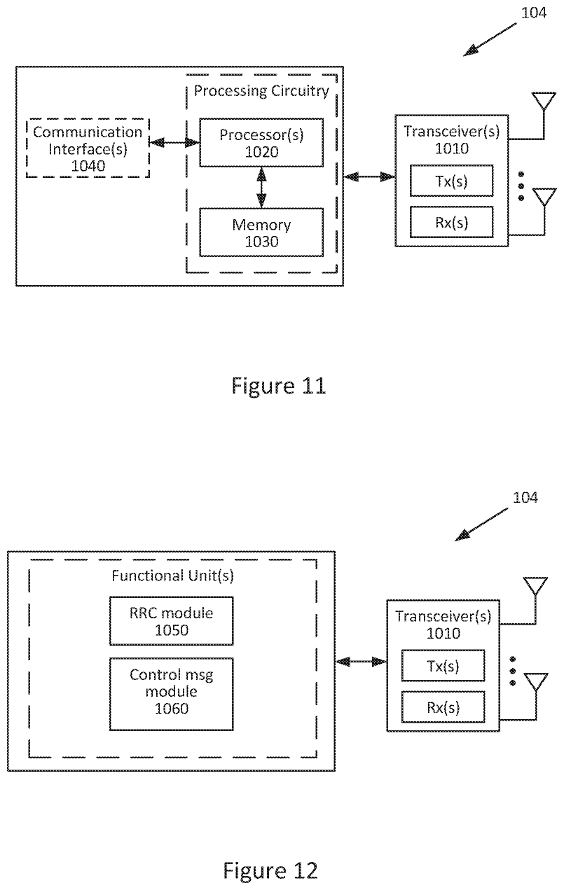

In some embodiments, the non-limiting term “network node” is used and it can correspond to any type of radio access node (or radio network node) or any network node, which can communicate with a UE and/or with another network node in a cellular or mobile or wireless communication system. Examples of network nodes are NodeB, MeNB, SeNB, a network node belonging to MCG or SCG, base station (BS), multi-standard radio (MSR) radio access node such as MSR BS, eNodeB, gNB network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, Self-organizing Network (SON), positioning node (e.g. E-SMLC), MDT, test equipment, etc. Example embodiments of a network node are described in more detail below with respect to FIG. 11.

In some embodiments, the term “radio access technology” (RAT) refers to any RAT e.g. UTRA, E-UTRA, narrow band internet of things (NB-IoT), WiFi, Bluetooth, next generation RAT (NR), 4G, 5G, etc. Any of the first and the second nodes may be capable of supporting a single or multiple RATs.

The term “radio node” used herein can be used to denote a UE or a network node.

In some embodiments, a UE can be configured to operate in carrier aggregation (CA) implying aggregation of two or more carriers in at least one of DL and UL directions. With CA, a UE can have multiple serving cells, wherein the term ‘serving’ herein means that the UE is configured with the corresponding serving cell and may receive from and/or transmit data to the network node on the serving cell e.g. on PCell or any of the SCells. The data is transmitted or received via physical channels e.g. PDSCH in DL, PUSCH in UL etc. A component carrier (CC) also interchangeably called as carrier or aggregated carrier, PCC or SCC is configured at the UE by the network node using higher layer signaling e.g. by sending RRC configuration message to the UE. The configured CC is used by the network node for serving the UE on the serving cell (e.g. on PCell, PSCell, SCell, etc.) of the configured CC. The configured CC is also used by the UE for performing one or more radio measurements (e.g. RSRP, RSRQ, etc.) on the cells operating on the CC, e.g. PCell, SCell or PSCell and neighboring cells.

In some embodiments, a UE can also operate in dual connectivity (DC) or multi-connectivity (MC). The multicarrier or multicarrier operation can be any of CA, DC, MC, etc. The term “multicarrier” can also be interchangeably called a band combination.

The term “radio measurement” used herein may refer to any measurement performed on radio signals. Radio measurements can be absolute or relative. Radio measurements can be e.g. intra-frequency, inter-frequency, CA, etc. Radio measurements can be unidirectional (e.g., DL or UL or in either direction on a sidelink) or bidirectional (e.g., RTT, Rx-Tx, etc.). Some examples of radio measurements: timing measurements (e.g., propagation delay, TOA, timing advance, RTT, RSTD, Rx-Tx, etc.), angle measurements (e.g., angle of arrival), power-based or channel quality measurements (e.g., path loss, received signal power, RSRP, received signal quality, RSRQ, SINR, SNR, interference power, total interference plus noise, RSSI, noise power, CSI, CQI, PMI, etc.), cell detection or cell identification, RLM, SI reading, etc. The measurement may be performed on one or more links in each direction, e.g., RSTD or relative RSRP or based on signals from different TPs of the same (shared) cell.

The term “signaling” used herein may comprise any of: high-layer signaling (e.g., via RRC or a like), lower-layer signaling (e.g., via a physical control channel or a broadcast channel), or a combination thereof. The signaling may be implicit or explicit. The signaling may further be unicast, multicast or broadcast. The signaling may also be directly to another node or via a third node.

The term “time resource” used herein may correspond to any type of physical resource or radio resource expressed in terms of length of time. Examples of time resources include: symbol, time slot, sub-frame, radio frame, TTI, interleaving time, etc. The term “frequency resource” may refer to sub-band within a channel bandwidth, subcarrier, carrier frequency, frequency band. The term “time and frequency resources” may refer to any combination of time and frequency resources.

Some examples of UE operation include: UE radio measurement (see the term “radio measurement” above), bidirectional measurement with UE transmitting, cell detection or identification, beam detection or identification, system information reading, channel receiving and decoding, any UE operation or activity involving at least receiving of one or more radio signals and/or channels, cell change or (re)selection, beam change or (re)selection, a mobility-related operation, a measurement-related operation, a radio resource management (RRM)-related operation, a positioning procedure, a timing related procedure, a timing adjustment related procedure, UE location tracking procedure, time tracking related procedure, synchronization related procedure, MDT-like procedure, measurement collection related procedure, a CA-related procedure, serving cell activation/deactivation, CC configuration/de-configuration, etc.

The 5G/NR networks can support a diverse set of use cases and a diverse set of deployment scenarios. The later includes deployment at both low frequencies (e.g. 100s of MHz), similar to LTE today, and very high frequencies (e.g. mm waves in the tens of GHz).

Similar to LTE, NR can use OFDM in both the downlink (i.e. from a network node, gNB, eNB, or base station, to a user equipment or UE). In the uplink (i.e. from UE to gNB), both DFT-spread OFDM and OFDM will be supported.

In the case of semi-persistent CSI-RS, the gNB first RRC configures the UE with the semi-persistent CSI-RS resources (as noted herein, for CSI acquisition, a single semi-persistent CSI-RS resource is contained within a CSI-RS resource set). The semi-persistent CSI-RS resource or semi-persistent CSI-RS resource set can then be activated via MAC CE signaling.

Quasi co-location (QCL) is one way to describe the relation between two different signals originating from the same TRP that can be received using the same spatial receiver parameters. As an example, a UE should be able to assume it can use the same receive beam when receiving the two difference signals that have spatial QCL. The spatial QCL relations between different types of reference RS and target RS are shown in Table 1 below. Also, shown in the table are the associated signaling methods. The last column of the table simply indicates that the target and reference RSs can belong to different component carriers (CCs) and different bandwidth parts (BWPs).

TABLE 1
Spatial QCL relations

| | | | | Reference RS and |
|---|---|---|---|---|
| | | | | Target RS should |
| | | | | belong to the |
| QCL | Reference | Target | Signaling | same CC/BWP or |
| parameter | RS | RS | method | not |
| Spatial | SS Block | P CSI-RS | RRC | Can be on |
| | (SSB) | | | different |
| | | | | CCs/BWPs |
| Spatial | SSB | SP CSI-RS | SP CSI-RS | Can be on |
| | | | activation | different |
| | | | signal | CCs/BWPs |
| Spatial | P CSI-RS | Another P | RRC | Can be on |
| | | CSI-RS | | different |
| | | | | CCs/BWPs |
| Spatial | SSB or | AP CSI-RS | RRC or RRC + | Can be on |
| | P/SP CSI- | | MAC CE for | different |
| | RS | | configuration, | CCs/BWPs |
| | | | indication with | |
| | | | DCI | |

In NR, it has been agreed to support a framework for dynamic QCL indication for PDSCH and PDCCH. This can be accomplished by configuration of a number of Transmission Configuration Indication (TCI) states. The TCI states can be considered analogous to PQI states in LTE that are configured when DCI format 2D is employed to support DL CoMP (multi-TRP) operation. In LTE, the DCI format 2D contains a PQI field that points to one of 4 RRC configured PQI states. Each PQI state provides the UE with the ID of an RRC configured CSI-RS that is transmitted from another TRP. When a particular PQI is signaled in DCI, the UE can assume that PDSCH DMRS is QCL with the CSI-RS indicated by PQI with respect to time and/or frequency parameters.

The TCI framework in NR supports similar operation. However, it may be used both in multi-TRP and single-TRP scenarios. Additionally, high-frequency (mm-wave) operation is supported by the addition of either SSB or CSI-RS IDs in a TCI state that may be used for the purposes of spatial QCL indication to aid in UE receive-side beamforming at mm-wave frequencies.

Due to UE movement/rotation, the CSI-RS or SSB ID in a TCI state that is used for the purposes of spatial QCL indication may need to be updated, or configured, on a continuous basis. The following RAN1 status for TCI state configuration and TCI state updates can be considered:

Support at least the explicit approach for the update of spatial QCL reference in a TCI state. Additional support may be required for an implicit update.

In the explicit approach, the TCI state is updated using either RRC or RRC+MAC-CE based approach

In the implicit approach, when a set of aperiodic CSI-RS resources are triggered, the triggering DCI includes a TCI state index which provides spatial QCL reference for the triggered set of CSI-RS resources. Following the measurement, the spatial QCL reference in the RS set corresponding to the indicated TCI state is updated based on the preferred CSI-RS determined by the UE. Other operations of implicit approaches are not precluded.

Down-select to one of the following 2 options for the DCI field size for TCI:

Alternative 1: A fixed number of bits (e.g. 2 or 3 bits).

Alternative 2: A higher layer signaling parameter indicates the number of bits (2 or 3).

Accordingly, RRC can configure a number of candidate TCI states for a UE, wherein each TCI state has a TCI ID and RS set or individual RS which are used for QCL indication. The configuration and update of TCI states can use a combination or RRC configuration and MAC CE. The latter can be used for TCI state updates.

It is also noted that the number of bits in the DCI field for indicating TCI states may be limited to 2 or 3 bits (the exact value to be down-selected is to be determined).

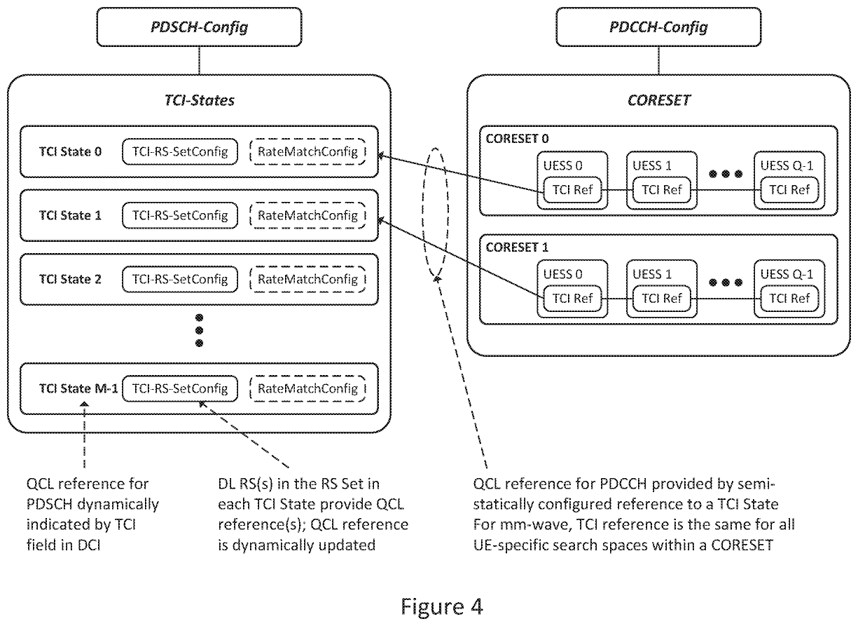

An example of the TCI framework is illustrated in FIG. 4. As discussed, a UE can be configured with multiple TCI states. For PDSCH, for example, eight of the TCI states can be activated via a MAC CE, and then DCI can indicate one of the TCI states.

Among the options described herein for the explicit update of spatial QCL reference in a TCI state, a flexible option is to use a combination of RRC and MAC CE since this allows the QCL reference in a TCI state to be dynamically updated. The MAC CEs for NR have not been defined. Hence, systems and methods for performing dynamic update of QCL reference in a TCI state via MAC CE messages and how to optimize the corresponding signaling of MAC CE will be considered.

Some embodiments include utilizing the combination of RRC and MAC CE approach to enable flexible options for configuring/updating the TCI state(s) with a spatial QCL reference. In some embodiments, if the number of bits available for indicating TCI states in DCI is limited (e.g. 2 or 3 bits), then there are only a small number of TCI states that can be RRC configured to a UE.

As described, each TCI state is associated with an RS set or an individual RS with reference signal IDs. Each RS within a TCI state can be associated with a set of Tx (transmit) and/or Rx (receive) beams. Note that one of the RSs associated with each TCI state will be used as a QCL reference for the corresponding TCI state at a given time. Based on dynamic layer-1 measurement reports sent by the UE to the gNB, the gNB can be made aware that a different set of Tx and/or Rx beams have become more appropriate to be used for downlink (DL) transmission (e.g. as opposed to/compared to the currently used set of Tx and/or Rx beams). This implies that the RS that is being currently used as the spatial QCL reference within a given TCI state should be updated to the new QCL reference RS which corresponds to the new set of Tx and/or Rx beams which have become more appropriate. In this case, an update of the spatial QCL reference(s) associated with a given TCI state can be beneficial. As part of the update, a new DL RS ID indicating the new QCL reference RS can be transmitted via MAC CE signaling.

Different types of DL reference signals (e.g. the SSB and the CSI-RS) can be used as reference RS for spatial QCL in a TCI state. Hence, different types of global RS indices (e.g. IDs) spanning different index spaces may be possible to convey in a MAC CE message updating the spatial QCL reference of a TCI state.

Some embodiments include methods for transmitting a MAC CE message for updating a QCL reference in a TCI state, comprising at least (1) an indicator of a TCI state to be updated, and/or (2) an indicator of a reference signal ID to be used as the new QCL reference for the indicated TCI state. The reference signal ID may indicate a reference signal of a reference signal type, wherein the reference signal type may be one of at least a first and a second reference signal type. The QCL reference can be a spatial QCL reference.

In a first embodiment, in addition to an indication of a TCI state to be updated, a DL RS Type identifier is included in a MAC CE message that updates the QCL reference, indicating the reference signal type of the reference signal. Additionally, included in the MAC CE message is a reference signal ID, indicating the reference signal to be used as the updated QCL reference. Based on the indicated reference signal type, the index space of the reference signal ID is known and the association between the reference signal ID and the actual reference signal can be determined.

In a second embodiment, a set of candidate reference signals are configured for each TCI state. Each reference signal in the candidate reference signal set can be at least of either a first or a second type of reference signal (e.g. “SSB” or “CSI-RS”). The configuration of the set of candidate reference signals for the TCI state can, in some embodiments, comprise a list of value pairs, where the first value in the value pair indicates the reference signal type and the second value in the value pair indicates a reference signal ID, conditioned on the reference signal type indicated by the first value in the value pair. In some embodiments, the reference signal IDs may span an index space constituting a global set of indices of all configured reference signal resources of that reference signal type.

Thus, in the general case, both SSBs and CSI-RS resources can be included in the set of candidate reference signals, enabling a MAC CE update of a TCI state with reference signals of either type. In these embodiments, the MAC CE message can contain an indication of a TCI state to be updated as well as an indication of the element within the set of candidate reference signals configured for the TCI state. In some embodiments, the indicator can be the index of the element of the set. In other embodiments, the indicator can be provided by a bitmap where set bit(s) (bit value(s)=‘1’) indicate the selected element(s) in the set.

An example illustration of the configuration of the set of candidate reference signals is provided in Table 2.

TABLE 2
Configuration of candidate reference signal set for one TCI state

| Index | RS Type | RS Index |
|---|---|---|
| 0 (Bits 00) | SSB | 2 |
| 1 (Bits 01) | CSI-RS | 1 |
| 2 (Bits 10) | CSI-RS | 2 |
| 3 (Bits 11) | CSI-RS | 3 |

In the example of Table 2, the candidate reference signal set for one TCI state may be RRC configured by the gNB to the UE, and the MAC CE message may indicate the index which conveys both RS type and RS index of the RS to be updated as the spatial QCL reference. In this example, the bits ‘00’, ‘01’, etc. may correspond to two bits in a MAC CE message.

In another example, some TCI states may be SSB “specific”, or CSI-RS “specific”. In this case, RRC configures a certain amount of SSBs as candidate reference signals for a certain TCI state, e.g. state 0, and then one uses MAC CE to pick one resource to be the “active” resource (e.g. the one to be used as the spatial QCL reference) in that TCI state. Another state can be configured with candidate P CSI-RS resources and MAC CE selects one of those to be used as spatial QCL reference for this state. One of those resources could be configured to be the initial active resource (e.g. the one to be used as the initial spatial QCL reference) as part of the RRC configuration. In some embodiments, the first reference signal in the set of candidate reference signals can be the initial active RS. In other embodiments, the candidate reference signal in the set that is to be the initial active RS can be explicitly indicated.

In a third embodiment, a single MAC CE message may update the spatial QCL references of multiple TCI states in the same message. Assuming a maximum of maxTCIStateUpdate number of TCI states that can be updated at the same time, the MAC CE message can include 2×maxTCIStateUpdate or 3×maxTCIStateUpdate bits that indicate the TCI states whose spatial QCL references are being updated. Assuming X candidate RSs are configured as candidate spatial QCL references within a TCI state and assuming the corresponding RS IDs can be represented by Y bits, the MAC CE message may include an additional X×Y×maxTCIStateUpdate bits to indicate the updated spatial QCL references for the maxTCIStateUpdate TCI states. In some variations, assuming the different RS types can be differentiated by Z bits, the MAC CE message can contain an additional Z×maxTCIStateUpdate bits to indicate the type of RS that is being updated as spatial QCL reference for the maxTCIState Update TCI states.

According to some embodiments, there may be no need to update the RRC configuration of the TCI states but requiring only indication with MAC CEs when the spatial QCL reference of a TCI state needs to be updated. Such a MAC CE has the index of the TCI state to be updated and index for the resource (out of the candidate RSs configured for this state) that is to be used as the spatial QCL reference for that TCI state.

In some embodiments, the set of candidate reference signals can be individually configured for each TCI state. In other embodiments, a separate set of candidate reference signals can be configured for each TCI state.

Example MAC CE:

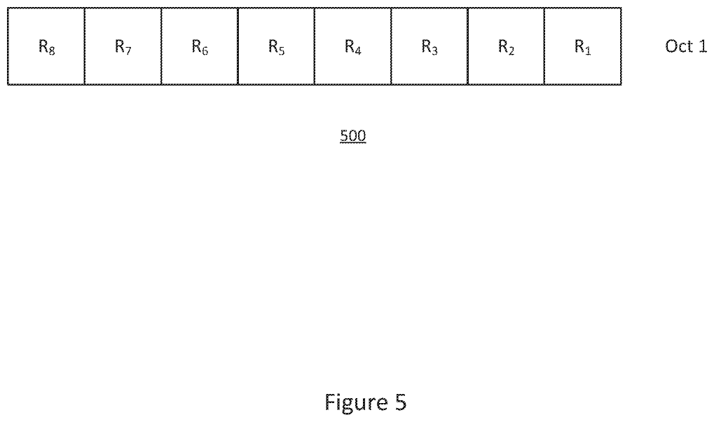

To indicate which TCI state is being updated, the first 2-3 bits can indicate the TCI state. The next bits can indicate an RS ID from the preconfigured RS IDs for that TCI state. As only one RS is selected as the QCL reference for each state, the MAC CE can indicate the RS ID corresponding to the selected RS. If different types of RSs are preconfigured for a TCI state, the DL RS Type identifier can also be indicated by one or more MAC CE bits as has been discussed herein. FIG. 5 illustrates an example of the first octet 500 of a MAC CE message as has been described herein.

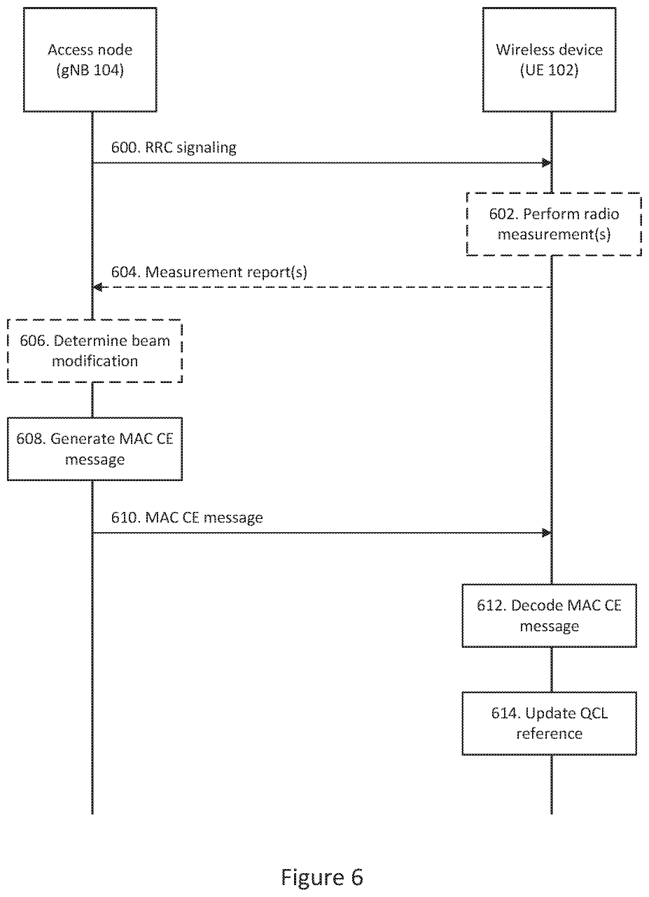

FIG. 6 is an example signaling diagram according to some embodiments. A wireless device, such as UE 102, receives RRC signaling from a network node, such as access node 104 (step 600). The RRC signaling can be used to configure a number of TCI states for the wireless device. Each TCI state can include a TCI state ID and a RS set, or one or more individual RS(s), which are used for QCL reference. Each RS within a TCI state can be associated with a set of one or more Tx (transmit) and/or Rx (receive) beams.

The wireless device can optionally perform one or more radio measurements as have been described herein (step 602). The wireless device can optionally transmit one or more radio measurement reports to at least one access node (step 604), according to those radio measurements.

The access node can optionally receive a measurement report from a wireless device (step 604). Optionally, the access node can determine, in accordance with the measurement report, that a modification to the beams used by the wireless device is required (step 606). In some embodiments, this can include determining that other Tx and/or Rx beams should be used for downlink transmission, e.g. instead of the current beams that are associated with a TCI state. In some embodiments, this can include determining that a QCL reference for a TCI state should be modified.

The access node generates a control message, such as a MAC CE message, for updating a QCL reference associated with a TCI state (step 608). In some embodiments, the MAC CE message includes an indication of the TCI state to be updated (e.g. TCI state ID). In some embodiments, the MAC CE message includes an indication of a reference signal identifier. The reference signal identifier can indicate a reference signal or a reference signal type. In some embodiments, the reference signal type can be one of SSB or CSI-RS. In one embodiment, the MAC CE message can include indication of a reference signal type and a reference signal index. In another embodiment, the MAC CE message can include a set of candidate reference signals. In another embodiment, the MAC CE message can include updates to the QCL references of multiple TCI states. The access node transmits the generated MAC CE message to the wireless device (step 610).

Following reception of the control message, such as the MAC CE message, the wireless device decodes the message (step 612). The wireless device can update the QCL reference of a TCI state in accordance with the received MAC CE message (step 614). This can include determining one or more of a TCI state to be updated, a reference signal identifier, a reference signal type to be updated, and/or a reference signal to be updated. In some embodiments, the updated reference signal can be selected from a set of candidate reference signals in accordance with the MAC CE message. In some embodiments, multiple reference signals associated with multiple states can be updated. In some embodiments, the reference signal(s) can correspond to Tx and/or Rx beams to be used by the wireless device.

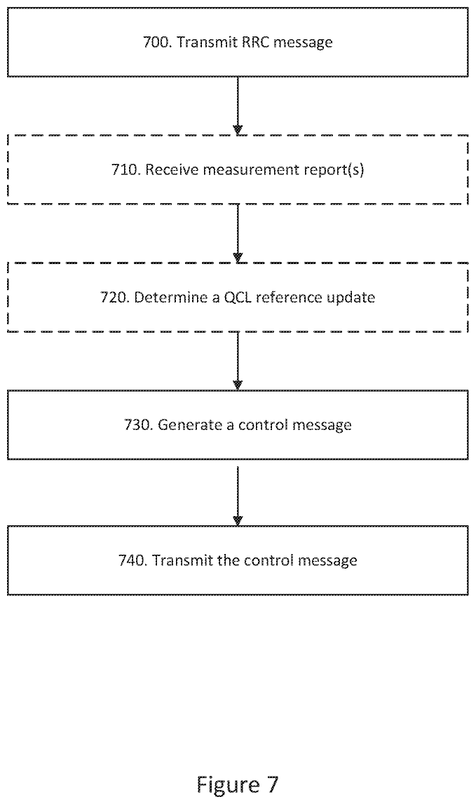

FIG. 7 is a flow chart illustrating a method which can be performed in a network node, such as gNB 104. The method can include:

Step 700: Transmitting a RRC message. The RRC message can include a plurality of TCI states. Each of the plurality of TCI states can include a TCI state identifier and at least one candidate reference signal for QCL reference for the corresponding TCI state.

Step 710 (optional): Receiving a radio measurement report(s) from a wireless device.

Step 720 (optional): Determining that a QCL reference associated with an active TCI state should be updated. This can include determining that a beam modification is needed for the wireless device. This determination can be made in accordance with the received measurement report(s). The determination can be that beams, other than the current beams, should be used for transmission/reception by the wireless device. The beams can be associated with an active TCI state.

Step 730: Generating a control message for updating a QCL reference associated with an active TCI state. The control message can be generated responsive to determining that a QCL reference and/or a beam modification is required. The control message can be a MAC CE. The control message can indicate one or more of a TCI state to be updated, a reference signal identifier, a reference signal type, a reference signal index and/or a reference signal. In some embodiments, the control message can indicate a set of candidate reference signals. In some embodiments, the control message can indicate multiple reference signals associated with multiple TCI states to be updated.

Step 740: Transmitting the generated control message to a wireless device.

It will be appreciated that one or more of the above steps can be performed simultaneously and/or in a different order. Also, steps illustrated in dashed lines are optional and can be omitted in some embodiments.

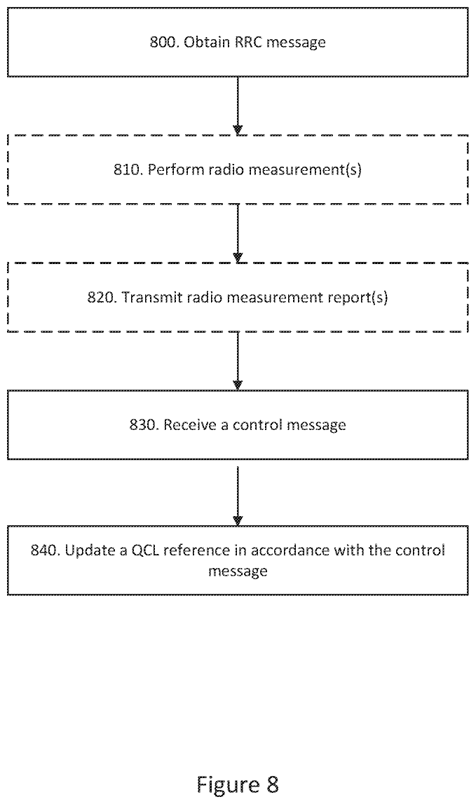

FIG. 8 is a flow chart illustrating a method which can be performed in a wireless device, such as UE 102. The method can include:

Step 800: Obtaining a RRC message. The RRC message can be received from a network node, such as access node 104. The RRC message can include a plurality of TCI states. Each of the plurality of TCI states can include a TCI state identifier and at least one candidate reference signal for QCL reference for the corresponding TCI state.

Step 810 (optional): Performing radio measurement(s).

Step 820 (optional): Transmitting radio measurement report(s) to an access node.

Step 830: Receiving a control message to update a QCL reference associated with an active TCI state. The control message can be a MAC CE. The control message can be received from an access node. The control message can indicate one or more of a TCI state to be updated, a reference signal identifier, a reference signal type, a reference signal index and/or a reference signal. In some embodiments, the control message can indicate a set of candidate reference signals. In some embodiments, the control message can indicate multiple reference signals associated with multiple TCI states to be updated.

Step 840: Updating a QCL reference for the active TCI state in accordance with the received control message. In some embodiments, updating the spatial QCL reference can include determining one or more of a TCI state to be updated, a reference signal identifier, a reference signal type to be updated, and/or a reference signal to be updated. In some embodiments, the reference signal can be selected from a set of candidate reference signals in accordance with the received control message. In some embodiments, multiple reference signals associated with multiple states can be updated in accordance with the received control message.

In some embodiments, the wireless device can be further configured and use Tx and/or Rx beams indicated reference signal to be used as the updated QCL reference as indicated by the received control message.

It will be appreciated that one or more of the above steps can be performed simultaneously and/or in a different order. Also, steps illustrated in dashed lines are optional and can be omitted in some embodiments.

FIG. 9 is a block diagram of an example wireless device, UE 102, in accordance with certain embodiments. UE 102 includes a transceiver 910, processor 920, and memory 930. In some embodiments, the transceiver 910 facilitates transmitting wireless signals to and receiving wireless signals from radio access node 104 (e.g., via transmitter(s) (Tx), receiver(s) (Rx) and antenna(s)). The processor 920 executes instructions to provide some or all of the functionalities described above as being provided by UE, and the memory 930 stores the instructions executed by the processor 920. In some embodiments, the processor 920 and the memory 930 form processing circuitry.

The processor 920 may include any suitable combination of hardware to execute instructions and manipulate data to perform some or all of the described functions of UE 102, such as the functions of UE 102 described above. In some embodiments, the processor 920 may include, for example, one or more computers, one or more central processing units (CPUs), one or more microprocessors, one or more application specific integrated circuits (ASICs), one or more field programmable gate arrays (FPGAs) and/or other logic.

The memory 930 is generally operable to store instructions, such as a computer program, software, an application including one or more of logic, rules, algorithms, code, tables, etc. and/or other instructions capable of being executed by a processor 920. Examples of memory 930 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information, data, and/or instructions that may be used by the processor 920 of UE 102.

In some embodiments, communication interface 940 is communicatively coupled to the processor 920 and may refer to any suitable device operable to receive input for network node 104, send output from network node 104, perform suitable processing of the input or output or both, communicate to other devices, or any combination of the preceding. The communication interface 940 may include appropriate hardware (e.g., port, modem, network interface card, etc.) and software, including protocol conversion and data processing capabilities, to communicate through a network.

Other embodiments of UE 102 may include additional components beyond those shown in FIG. 9 that may be responsible for providing certain aspects of the UE's functionalities, including any of the functionalities described above and/or any additional functionalities (including any functionality necessary to support the solution described above). As just one example, UE 102 may include input devices and circuits, output devices, and one or more synchronization units or circuits, which may be part of the processor. Input devices include mechanisms for entry of data into UE 102. For example, input devices may include input mechanisms, such as a microphone, input elements, a display, etc. Output devices may include mechanisms for outputting data in audio, video and/or hard copy format. For example, output devices may include a speaker, a display, etc.

In some embodiments, the UE 102 can comprise a series of functional units or modules configured to implement the functionalities of the UE described above. Referring to FIG. 10, in some embodiments, the UE 102 can comprise a TCI state module 950 for configuring a plurality of TCI states including candidate reference signals; and a QCL update module 960 for updating a QCL reference for an active TCI state.

It will be appreciated that the various modules may be implemented as combination of hardware and software, for instance, the processor, memory and transceiver(s) of UE 102 shown in FIG. 9. Some embodiments may also include additional modules to support additional and/or optional functionalities.

FIG. 11 is a block diagram of an example network node, e.g. access node 104, in accordance with certain embodiments. Network node 104 may include one or more of a transceiver 1010, processor 1020, memory 1030, and network interface 1040. In some embodiments, the transceiver 1010 facilitates transmitting wireless signals to and receiving wireless signals from UE 102 (e.g., via transmitter(s) (Tx), receiver(s) (Rx), and antenna(s)). The processor 1020 executes instructions to provide some or all of the functionalities described above as being provided by an access node 104, the memory 1030 stores the instructions executed by the processor 1020. In some embodiments, the processor 1020 and the memory 1030 form processing circuitry. The network interface 1040 communicates signals to backend network components, such as a gateway, switch, router, Internet, Public Switched Telephone Network (PSTN), core network nodes or radio network controllers, etc.

The processor 1020 may include any suitable combination of hardware to execute instructions and manipulate data to perform some or all of the described functions of access node 104, such as those described above. In some embodiments, the processor 1020 may include, for example, one or more computers, one or more central processing units (CPUs), one or more microprocessors, one or more application specific integrated circuits (ASICs), one or more field programmable gate arrays (FPGAs) and/or other logic.

The memory 1030 is generally operable to store instructions, such as a computer program, software, an application including one or more of logic, rules, algorithms, code, tables, etc. and/or other instructions capable of being executed by a processor 1020. Examples of memory 1030 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, the network interface 1040 is communicatively coupled to the processor 1020 and may refer to any suitable device operable to receive input for access node 104, send output from access node 104, perform suitable processing of the input or output or both, communicate to other devices, or any combination of the preceding. The network interface 1040 may include appropriate hardware (e.g., port, modem, network interface card, etc.) and software, including protocol conversion and data processing capabilities, to communicate through a network.

Other embodiments of access node 104 may include additional components beyond those shown in FIG. 11 that may be responsible for providing certain aspects of the access node's functionalities, including any of the functionalities described above and/or any additional functionalities (including any functionality necessary to support the solutions described above). The various different types of network nodes may include components having the same physical hardware but configured (e.g., via programming) to support different radio access technologies, or may represent partly or entirely different physical components.

In some embodiments, the network node 104, which can be, for example, a radio access node, may comprise a series of modules configured to implement the functionalities of the network node 104 described above. Referring to FIG. 12, in some embodiments, the network node 104 can comprise a RRC module 1050 for transmitting a RRC message including configuration information associated with a plurality of TCI states, and a control message module 1060 for generating and transmitting a control message to update a QCL reference for an active TCI state.

It will be appreciated that the various modules may be implemented as combination of hardware and software, for instance, the processor, memory and transceiver(s) of network node 120 shown in FIG. 11. Some embodiments may also include additional modules to support additional and/or optional functionalities.

Processors, interfaces, and memory similar to those described with respect to FIGS. 9 and 11 may be included in other network nodes (such as core network node 106). Other network nodes may optionally include or not include a wireless interface (such as the transceiver described in FIGS. 9 and 11).

Some embodiments may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause processing circuitry (e.g. a processor) to perform steps in a method according to one or more embodiments. Those of ordinary skill in the art will appreciate that other instructions and operations necessary to implement the described embodiments may also be stored on the machine-readable medium. Software running from the machine-readable medium may interface with circuitry to perform the described tasks.

The above-described embodiments are intended to be examples only. Alterations, modifications and variations may be effected to the particular embodiments by those of skill in the art without departing from the scope of the description.

### Glossary

The present description may comprise one or more of the following abbreviation:
1×RTT CDMA2000 1×Radio Transmission Technology
3GPP Third Generation Partnership Project
5G Fifth Generation
ABS Almost Blank Subframe
ACK Acknowledgement
ADC Analog-to-digital conversion
AGC Automatic gain control
AN Access Network
ANR Automatic neighbor relations
AP Access point
ARQ Automatic Repeat Request
AS Access Stratum
AWGN Additive White Gaussian Noise band
BCCH Broadcast Control Channel
BCH Broadcast Channel
BLER Block error rate
BS Base Station
BSC Base station controller
BTS Base transceiver station
CA Carrier Aggregation
CC Component carrier
CCCH SDU Common Control Channel SDU
CDMA Code Division Multiplexing Access
CG Cell group
CGI Cell Global Identifier
CP Cyclic Prefix
CPICH Ec/No CPICH Received energy per chip divided by the power density in the
CPICH Common Pilot Channel
CQI Channel Quality information
C-RNTI Cell RNTI
CRS Cell-specific Reference Signal
CSG Closed subscriber group
CSI Channel State Information
DAS Distributed antenna system
DC Dual connectivity
DCCH Dedicated Control Channel
DCI Downlink Control Information
DFT Discrete Fourier Transform
DL Downlink
DL-SCH Downlink shared channel
DMRS Demodulation Reference Signal
DRX Discontinuous Reception
DTCH Dedicated Traffic Channel
DTX Discontinuous Transmission
DUT Device Under Test
EARFCN Evolved absolute radio frequency channel number
ECCE Enhanced Control Channel Element
ECGI Evolved CGI
E-CID Enhanced Cell-ID (positioning method)
eMBB Enhanced Mobile Broadband
eNB E-UTRAN NodeB or evolved NodeB
ePDCCH enhanced Physical Downlink Control Channel
EPS Evolved Packet System
E-SMLC evolved Serving Mobile Location Center
E-UTRA Evolved UTRA
E-UTRAN Evolved UTRAN
FDD Frequency Division Duplex
FDM Frequency Division Multiplexing
FFT Fast Fourier transform
GERAN GSM EDGE Radio Access Network
gNB 5G radio base station
GSM Global System for Mobile communication
HARQ Hybrid Automatic Repeat Request
HD-FDD Half duplex FDD
HO Handover
HRPD High Rate Packet Data
HSPA High Speed Packet Access
IE Information Element
LCMS Level of Criticality of the Mobility State
LPP LTE Positioning Protocol
LTE Long-Term Evolution
M2M Machine to Machine
MAC Medium Access Control
MBMS Multimedia Broadcast Multicast Services
MBSFN ABS MBSFN Almost Blank Subframe
MB SFN Multimedia Broadcast multicast service Single Frequency Network
MCG Master cell group
MCS Modulation and coding scheme
MDT Minimization of Drive Tests
MeNB Master eNode B
MIB Master Information Block
MME Mobility Management Entity
MPDCCH MTC Physical Downlink Control Channel
MRTD Maximum Receive Timing Difference
MSC Mobile Switching Center
Msg Message
MSR Multi-standard Radio
MTC Machine Type Communication
NACK Negative acknowledgement
NAS Non-Access Stratum
NDI Next Data Indicator
NPBCH Narrowband Physical Broadcast Channel
NPDCCH Narrowband Physical Downlink Control Channel
NR New Radio
O&M Operation and Maintenance
OCNG OFDMA Channel Noise Generator
OFDM Orthogonal Frequency Division Multiplexing
OFDMA Orthogonal Frequency Division Multiple Access
OSS Operations Support System
OTDOA Observed Time Difference of Arrival
PBCH Physical Broadcast Channel
PCC Primary Component Carrier
P-CCPCH Primary Common Control Physical Channel
PCell Primary Cell
PCFICH Physical Control Format Indicator Channel
PCG Primary Cell Group
PCH Paging Channel
PCI Physical Cell Identity
PDCCH Physical Downlink Control Channel
PDSCH Physical Downlink Shared Channel
PDU Protocol Data Unit
PGW Packet Gateway
PHICH Physical HARQ indication channel
PLMN Public Land Mobile Network
PMI Precoder Matrix Indicator
PRACH Physical Random Access Channel
ProSe Proximity Service
PRS Positioning Reference Signal
PSC Primary serving cell
PSCell Primary SCell
PSS Primary Synchronization Signal
PSSS Primary Sidelink Synchronization Signal
PUCCH Physical Uplink Control Channel
PUSCH Physical Uplink Shared Channel
QAM Quadrature Amplitude Modulation
RA Random Access
RACH Random Access Channel
RAN Radio Access Network
RAT Radio Access Technology
RB Resource Block
RF Radio Frequency
RLM Radio Link Management
RNC Radio Network Controller
RNTI Radio Network Temporary Identifier
RRC Radio Resource Control
RRH Remote Radio Head
RRM Radio Resource Management
RRU Remote Radio Unit
RSCP Received Signal Code Power
RSRP Reference Signal Received Power
RSRQ Reference Signal Received Quality
RS SI Received Signal Strength Indicator
RSTD Reference Signal Time Difference
SCC Secondary Component Carrier
SCell Secondary Cell
SCG Secondary Cell Group
SCH Synchronization Channel
SDU Service Data Unit
SeNB Secondary eNodeB
SFN System Frame/Frequency Number
SGW Serving Gateway
SI System Information
SIB System Information Block
SINR Signal to Interference and Noise Ratio
SNR Signal Noise Ratio
SPS Semi-persistent Scheduling
SON Self-organizing Network
SR Scheduling Request
SRS Sounding Reference Signal
SSC Secondary Serving Cell
SSS Secondary synchronization signal
SSSS Secondary Sidelink Synchronization Signal
TA Timing Advance
TAG Timing Advance Group
TDD Time Division Duplex
TDM Time Division Multiplexing
TRP Transmission/Reception Point or Transmit/Receive Point
TTI Transmission Time Interval
Tx Transmitter
UARFCN UMTS Absolute Radio Frequency Channel Number
UE User Equipment
UL Uplink
UMTS Universal Mobile Telecommunication System
URLLC Ultra-Reliable Low Latency Communication
UTRA Universal Terrestrial Radio Access
UTRAN Universal Terrestrial Radio Access Network
V2I Vehicle-to-Infrastructure
V2P Vehicle-to-Pedestrian
V2X Vehicle-to-X
WCDMA Wide CDMA
WLAN Wireless Local Area Network

1. A method performed by a wireless device, the method comprising:
obtaining a radio resource control (RRC) message including a plurality of Transmission Configuration Indicator (TCI) states, wherein each of the plurality of TCI states includes a TCI state identifier and at least one candidate reference signal for quasi co-location (QCL) reference;
receiving a control message including an identifier of an active TCI state to be updated and an indication of a reference signal to be used as an updated QCL reference for the identified active TCI state; and
updating the QCL reference for the identified active TCI state to the indicated reference signal.

2. The method of claim 1, wherein the control message is a Medium Access Control (MAC) control element (CE).

3. The method of claim 1, wherein the indication of a reference signal indicates at least one of a reference signal type and a reference signal to be used as the updated QCL reference.

4. The method of claim 1, wherein the indication of a reference signal indicates a reference signal index to be used as the updated QCL reference.

5. The method of claim 1, wherein the indicated reference signal is one of the candidate reference signals for the active TCI state.

6. The method of claim 1, wherein the control message includes updated QCL references for a plurality of active TCI states.

7. The method of claim 1, further comprising, performing at least one radio measurement.

8. The method of claim 7, further comprising, transmitting a radio measurement report to a network node.

9. The method of claim 1, further comprising, using at least one of a transmission and reception beam associated with the indicated reference signal to be used as the updated QCL reference.

10. The method of claim 1, wherein the RRC message is received from a network node.

11. The method of claim 1, wherein the control message is received from a network node.

12. A wireless device comprising a radio interface and processing circuitry configured to:
obtain a radio resource control (RRC) message including a plurality of Transmission Configuration Indicator (TCI) states, wherein each of the plurality of TCI states includes a TCI state identifier and at least one candidate reference signal for quasi co-location (QCL) reference;
receive a control message including an identifier of an active TCI state to be updated and an indication of a reference signal to be used as an updated QCL reference for the identified active TCI state; and
update the QCL reference for the identified active TCI state to the indicated reference signal.

13. The wireless device of claim 12, wherein the control message is a Medium Access Control (MAC) control element (CE).

14. The wireless device of claim 12, wherein the indication of a reference signal indicates at least one of a reference signal type and a reference signal to be used as the updated QCL reference.

15. The wireless device of claim 12, wherein the indication of a reference signal indicates a reference signal index to be used as the updated QCL reference.

16. The wireless device of claim 12, wherein the indicated reference signal is one of the candidate reference signals for the active TCI state.

17. The wireless device of claim 12, wherein the control message includes updated QCL references for a plurality of active TCI states.

18. The wireless device of claim 12, further configured to perform at least one radio measurement.

19. The wireless device of claim 18, further configured to transmit a radio measurement report to a network node.

20. The wireless device of claim 12, further configured to use at least one of a transmission and reception beam associated with the indicated reference signal to be used as the updated QCL reference.

21. A method performed by a network node, the method comprising:
transmitting a radio resource control (RRC) message including a plurality of Transmission Configuration Indicator (TCI) states, wherein each of the plurality of TCI states includes a TCI state identifier and at least one candidate reference signal for quasi co-location (QCL) reference;
generating a control message including an identifier of an active TCI state to be updated and an indication of a reference signal to be used as an updated QCL reference for the identified active TCI state; and
transmitting the control message.

22. The method of claim 21, wherein the control message is a Medium Access Control (MAC) control element (CE).

23. The method of claim 21, wherein the indication of a reference signal indicates at least one of a reference signal type and a reference signal to be used as the updated QCL reference.

24. The method of claim 21, wherein the indication of a reference signal indicates a reference signal index to be used as the updated QCL reference.

25. The method of claim 21, wherein the indicated reference signal is one of the candidate reference signals for the active TCI state.

26. The method of claim 21, wherein the control message includes updated QCL references for a plurality of active TCI states.

27. The method of claim 21, further comprising, determining that a QCL reference associated with the active TCI state should be updated.

28. The method of claim 27, wherein the control message is generated in response to determining that the QCL reference associated with the active TCI state should be updated.

29. The method of claim 21, further comprising, receiving at least one radio measurement report from a wireless device.

30. The method of claim 29, further comprising, determining that the QCL reference associated with the active TCI state should be updated in accordance with the radio measurement report.

31. The method of claim 21, wherein the RRC message is transmitted to a wireless device.

32. The method of claim 21, wherein the control message is transmitted to a wireless device.

33. A network node comprising a radio interface and processing circuitry configured to:
transmit a radio resource control (RRC) message including a plurality of Transmission Configuration Indicator (TCI) states, wherein each of the plurality of TCI states includes a TCI state identifier and at least one candidate reference signal for quasi co-location (QCL) reference;
generate a control message including an identifier of an active TCI state to be updated and an indication of a reference signal to be used as an updated QCL reference for the identified active TCI state; and
transmit the control message.

34. The network node of claim 33, wherein the control message is a Medium Access Control (MAC) control element (CE).

35. The network node of claim 33, wherein the indication of a reference signal indicates at least one of a reference signal type and a reference signal to be used as the updated QCL reference.

36. The network node of claim 33, wherein the indication of a reference signal indicates a reference signal index to be used as the updated QCL reference.

37. The network node of claim 33, wherein the indicated reference signal is one of the candidate reference signals for the active TCI state.

38. The network node of claim 33, wherein the control message includes updated QCL references for a plurality of active TCI states.

39. The network node of claim 33, further configured to determine that a QCL reference associated with the active TCI state should be updated.

40. The network node of claim 39, wherein the control message is generated in response to determining that the QCL reference associated with the active TCI state should be updated.

41. The network node of claim 33, further configured to receive at least one radio measurement report from a wireless device.

42. The network node of claim 41, further configured to determine that the QCL reference associated with the active TCI state should be updated in accordance with the radio measurement report.
